(19) United States
(12) Patent Application Publication
(10) Pub. No.: US 2010/0143650 A1
(43) Pub. Date: Jun. 10, 2010

(54) CASING AND METHOD FOR MANUFACTURING THE SAME

(75) Inventors: Chia Ming Tsai, Taipei City (TW); Chih Chieh Chou, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Pegatron Corporation, Taipei City (TW)

(21) Appl. No.: 12/632,473

(22) Filed: Dec. 7, 2009

(30) Foreign Application Priority Data
Dec. 9, 2008 (TW) 097147868

(51) Int. Cl. B32B 3/10; B29C 43/20; B29C 65/02; B32B 3/00

(52) U.S. Cl. 428/139; 264/259; 264/248; 264/101; 428/174

(57) ABSTRACT

This invention discloses a casing and a method for manufacturing the same. The casing includes a fiber-reinforced thermosetting polymeric mat and a fiber-reinforced thermoplastic polymeric mat. The fiber-reinforced thermosetting polymeric mat is molded to have a predetermined shape with a curved inner surface. The fiber-reinforced thermoplastic polymeric mat is molded on the inner surface of the fiber-reinforced thermosetting polymeric mat and agrees with the curved inner surface.

### BACKGROUND OF THE INVENTION

1. Field of the Invention

The invention relates to a casing and a method for manufacturing the same and, more particularly, to a casing manufactured by a fiber-reinforced polymeric mat and a method for manufacturing the same.

2. Description of the Prior Art

To reduce weight, a plurality of polymers such as thermosetting resin or thermoplastic resin have been widely applied to casings of electronic devices. Further to improve strength of a casing made of a polymer, application of fiber-reinforced thermosetting polymers and fiber-reinforced thermoplastic polymers has been gradually widened. As people begin to require aesthetics of appearances of electronic devices, an outer surface of a casing made of a fiber-reinforced polymer can provide a grain or texture of the fabric used by the casing thus to present a decorative effect. However, different manufacturing processes are needed by the fiber-reinforced thermosetting polymer or the fiber-reinforced thermoplastic polymer to manufacture a casing.

When the fiber-reinforced thermosetting polymer is used to manufacture a casing, a vacuum molding process is generally performed. A fiber-reinforced thermosetting polymeric mat is first cut and then is disposed at an inner wall of a mold. Then, the mold where the fiber-reinforced thermosetting polymeric mat is disposed is disposed in a vacuum pan further to perform a vacuum pumping process and to rise to a proper temperature. Finally, the mold where the fiber-reinforced thermosetting polymeric mat is disposed is taken away from the vacuum pan, and the casing manufactured by processing the fiber-reinforced thermosetting polymeric mat is separated from the mold. If a structural part needs to be assembled at the inner wall of the casing manufactured by the fiber-reinforced thermosetting polymeric mat, the structural part can be assembled at the inner wall of the casing manufactured by the fiber-reinforced thermosetting polymeric mat just in a dispensing mode or via twin adhesive. Apparently, the join strength of the structural part assembled at the inner wall of the casing manufactured by the fiber-reinforced thermosetting polymeric mat is rather weak.

When the fiber-reinforced thermoplastic polymer is used to manufacture a casing with a structural part, a hot press molding process is performed. A fiber-reinforced thermoplastic polymeric mat is first cut and then is disposed at an inner wall of a lower mold. Then, the structural part is disposed in an upper mold. Then, the upper mold and the lower mold are closed further to perform the hot press molding process. In the hot press molding process, the structural part may be inserted into the fiber-reinforced thermoplastic polymeric mat with molten surfaces further to cause the structural part to be partly molten, thus to allow the structural part to be joined to the inner wall of the casing manufactured by the fiber-reinforced thermoplastic polymeric mat. Apparently, the join strength of the structural part disposed at the inner wall of the casing manufactured by the fiber-reinforced thermoplastic polymeric mat is rather strong. However, in the hot press molding process, the fiber grain of the fiber-reinforced thermoplastic polymeric mat may be deformed due to the flow of the molten structural part, further to deteriorate the appearance of the formed casing thus to fail to provide a better grain and texture.

With continuous development of the fiber-reinforced polymers applied to the casing manufacture, the manufacturing technique combining the advantages of the fiber-reinforced thermosetting polymer and the fiber-reinforced thermoplastic polymer applied to the casing manufacture and without the disadvantages thereof is still not provided.

### SUMMARY OF THE INVENTION

One objective of this invention is to provide a casing and a method for manufacturing the same. According to the invention, the casing combines advantages of a fiber-reinforced thermosetting polymer and a fiber-reinforced thermoplastic polymer applied to the casing manufacture. Thus, the casing has an outer surface with a better grain and texture, and better join strength between the casing and a structural part assembled at an inner wall of the formed casing is provided.

According to one aspect of the invention, the invention provides a casing. The casing includes a fiber-reinforced thermosetting polymeric mat and a fiber-reinforced thermoplastic polymeric mat. The fiber-reinforced thermosetting polymeric mat is molded to have a predetermined shape with a curved inner surface according to a needed appearance. The fiber-reinforced thermoplastic polymeric mat is molded on the inner surface of the fiber-reinforced thermosetting polymeric mat and agrees with the curved inner surface.

According to another aspect of the invention, the invention provides a method for manufacturing a casing. According to the method, a fiber-reinforced thermosetting polymeric mat is first molded to allow the fiber-reinforced thermosetting polymeric mat to have a predetermined shape with a curved inner surface. Then, a fiber-reinforced thermoplastic polymeric mat is disposed on the inner surface of the fiber-reinforced thermosetting polymeric mat to allow the fiber-reinforced thermoplastic polymeric mat to agree with the curved inner surface. Finally, the fiber-reinforced thermoplastic polymeric mat is molded.

These and other features, aspects, and advantages of the present invention will become better understood with regard to the following description, appended claims, and accompanying drawings.

### BRIEF DESCRIPTION OF THE APPENDED DRAWINGS

FIG. 1A is a schematic diagram showing a casing and a section thereof according to one preferred embodiment of the invention;

FIG. 1B is a schematic diagram showing a casing and a section thereof according to another preferred embodiment of the invention; and

FIG. 2A to FIG. 2D are sectional schematic diagrams corresponding to a method for manufacturing a casing according to one preferred embodiment of the invention.

### DETAILED DESCRIPTION OF THE INVENTION

This invention provides a casing and a method for manufacturing the same. According to the invention, the casing combines advantages of a fiber-reinforced thermosetting polymer and a fiber-reinforced thermoplastic polymer applied to casing manufacture and does not have disadvantages of the two materials when they are respectively applied to the casing manufacture. Preferred embodiments of the invention are described in detail hereinafter. Thereby, the features, aspects, advantages, and feasibility of mass production of products are described.

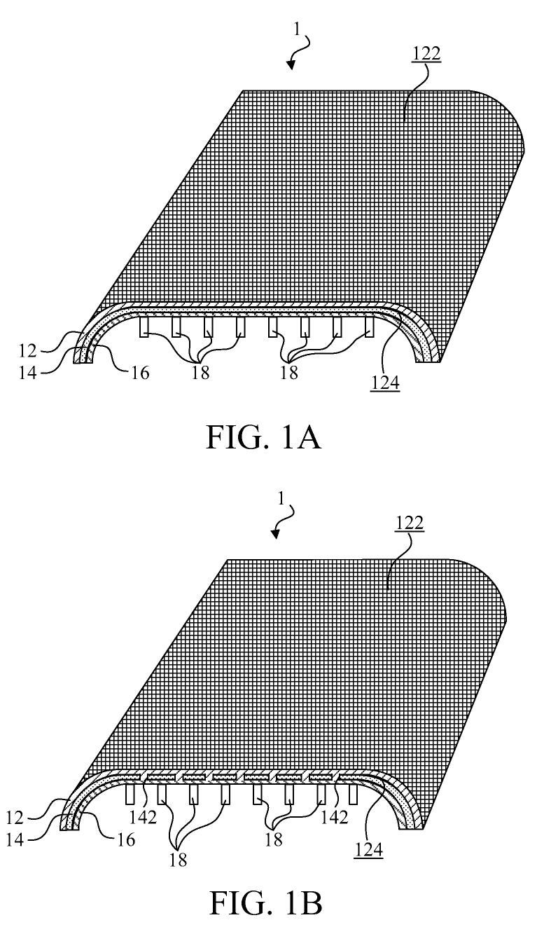

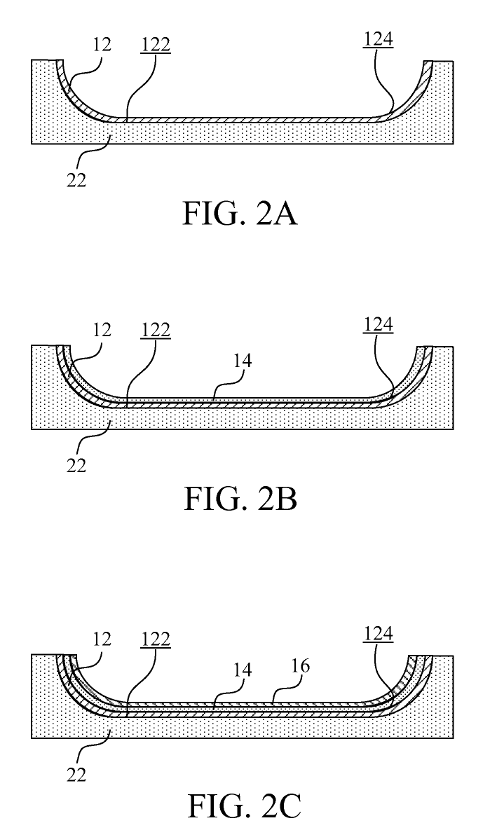

FIG. 1A is a schematic diagram showing a casing 1 and a section thereof according to one preferred embodiment of the invention. Please refer to FIG. 1A. According to one preferred embodiment of the invention, the casing 1 includes a fiber-reinforced thermosetting polymeric mat 12 and a fiber-reinforced thermoplastic polymeric mat 16.

The fiber-reinforced thermosetting polymeric mat 12 is first molded to have a predetermined shape. The predetermined shape has a curved inner surface 124. The opposite surface of the curved inner surface 124 is a decorative outer surface 122. That is, the outer surface of the fiber-reinforced thermosetting polymeric mat 12 has a fabric grain and texture to present an appearance vision effect.

In one embodiment, the fiber-reinforced thermosetting polymeric mat 12 may be molded via a vacuum molding process.

The fiber-reinforced thermoplastic polymeric mat 16 is molded on the inner surface 124 of the fiber-reinforced thermosetting polymeric mat 12 and agrees with the curved inner surface 124. In one embodiment, the fiber-reinforced thermoplastic polymeric mat 16 may be molded via a hot press molding process to allow the fiber-reinforced thermoplastic mat 16 to be joined to the fiber-reinforced thermosetting polymeric mat 12.

In FIG. 1A, in another embodiment, the casing 1 further includes a structural part 18. Particularly, the structural part 18 is joined to the fiber-reinforced thermoplastic polymeric mat 16 via a hot press molding process. Further, in the hot press molding process, the fiber-reinforced thermoplastic polymeric mat 16 and the fiber-reinforced thermosetting polymeric mat 12 are joined together.

To prevent a polymer of the fiber-reinforced thermoplastic polymeric mat 16 from permeating into the fiber-reinforced thermosetting polymeric mat 12 in the hot press molding process further to damage appearance of the molded fiber-reinforced thermosetting polymeric mat 12, in FIG. 1A, in another preferred embodiment, the casing further includes a buffer layer 14. The buffer layer 14 is disposed between the fiber-reinforced thermoplastic polymeric mat 16 and the fiber-reinforced thermosetting polymeric mat 12. That is, the fiber-reinforced thermoplastic polymeric mat 16 is disposed on the buffer layer 14. In the hot press molding process, the fiber-reinforced thermoplastic polymeric mat 16, the buffer layer 14, and the fiber-reinforced thermosetting polymeric mat 12 are joined together.

However, provision of the buffer layer 14 is just one preferred embodiment. The invention is not limited thereto. Since the fiber-reinforced thermosetting polymeric mat 12 is first molded via a vacuum molding process, in the succeeding process of disposing the fiber-reinforced thermoplastic polymeric mat and combining the fiber-reinforced thermoplastic polymeric mat with the structural part, when the proper temperature or pressure is controlled and the molded fiber-reinforced thermosetting polymeric mat 12 is principally not damaged, the buffer layer 14 can be omitted.

In one embodiment, the buffer layer 14 may be made of a metal material or a polymer. The buffer layer 14 may allow the casing 1 to have other physical characteristics such as protection against electromagnetic interference.

To improve the join strength between the fiber-reinforced thermoplastic polymeric mat 18, the buffer layer 14, and the fiber-reinforced thermosetting polymeric mat 12, in FIG. 1B, in another preferred embodiment, the buffer layer 14 has a plurality of through holes 142. In the hot press molding process, a part of the fiber-reinforced thermoplastic polymeric mat 16 passes through the through holes 142 further to be joined to the buffer layer 14 or the fiber-reinforced thermosetting polymeric mat 12. Thereby, the join strength of the fiber-reinforced thermoplastic polymeric mat 16, the buffer layer 14, and the fiber-reinforced thermosetting polymeric mat 12 is improved.

The elements in FIG. 1B having the same marks with that in FIG. 1A are the material layers mentioned above. Therefore, they are not described for a concise purpose.

The design of the buffer layer with holes is not necessary. The thermosetting polymeric mat is first molded, and in the hot press molding process, the thermoplastic plastic included by the fiber-reinforced thermoplastic polymeric mat and a part of a thermoplastic structural part may be melted and then solidified. When solidified, the molten part of the structural part may be fused to the fiber-reinforced thermoplastic polymeric mat to be combined with the molten thermoplastic plastic. At that moment, the molten thermoplastic plastic of the fiber-reinforced thermoplastic polymeric mat may be combined or solidified to the inner layer of the molded fiber-reinforced thermosetting polymeric mat. In addition, after the fiber-reinforced polymeric mat is molded, the inner layer thereof may present a natural rough surface of a fiber caused by the different processes, and the rough surface can improve the join strength between the structural part and the thermoplastic polymeric mat.

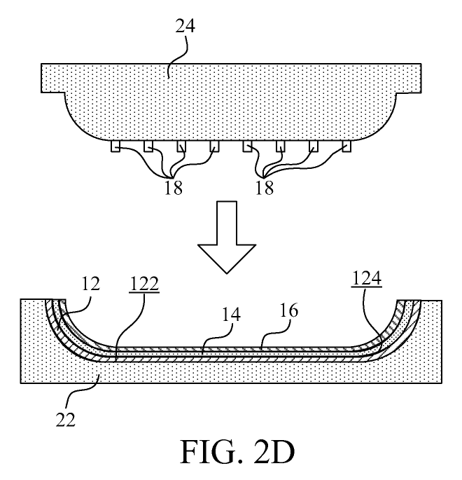

FIG. 2A to FIG. 2D are sectional schematic diagrams corresponding to a method for manufacturing a casing according to one preferred embodiment of the invention. The method is described in detail hereinafter.

According to the method, a fiber-reinforced thermosetting polymeric mat 12 is first molded to allow the fiber-reinforced thermosetting polymeric mat 12 to have a predetermined shape. In one embodiment, in FIG. 2A, the fiber-reinforced thermosetting polymeric mat 12 is first cut and then is disposed at an inner wall of a lower mold 22. Then, the lower mold 22 where the fiber-reinforced thermosetting polymeric mat 12 is disposed is disposed in a vacuum pan (not shown in FIG. 2A) further to perform a vacuum pumping process and to rise to a proper temperature. Particularly, after the lower mold 22 where the fiber-reinforced thermosetting polymeric mat 12 is disposed is taken away from the vacuum pan, the casing is not separated from the lower mold 22, and the next process is performed directly. The predetermined shape has a curved inner surface 124. In addition, the opposite surface of the curved inner surface 124 is a decorative outer surface 122.

Then, according to the method, a buffer layer 14 is disposed on the inner surface 124 of the fiber-reinforced thermosetting polymeric mat 12 to allow the buffer layer 14 to agree with the curved inner surface 124 as shown in FIG. 2B.

Afterwards, in FIG. 2C, according to the method, a fiber-reinforced thermoplastic polymeric mat 16 is disposed on the buffer layer 14 to allow the fiber-reinforced thermoplastic polymeric mat 16 to agree with the predetermined shape. If the material is proper and the injection parameter is controlled properly, there is no need to provide the buffer layer 14, and the fiber-reinforced thermoplastic polymeric mat 16 may be directly disposed on the inner surface 124 of the fiber-reinforced thermosetting polymeric mat 12.

Finally, via a hot press molding process, the fiber-reinforced thermoplastic polymeric mat 16 is molded. Particularly, in the hot press molding process, the fiber-reinforced thermosetting polymeric mat 12, the buffer layer 14, and the fiber-reinforced thermoplastic polymeric mat 16 are joined together. Then, after the mold and the casing are separated from each other, the casing is completed. If a structural part needs to be assembled at the inner wall of the casing, the hot press molding process also needs to be performed to allow the structural part 18 to be joined to the fiber-reinforced thermoplastic polymeric mat 16. In one embodiment, in FIG. 2D, an upper mold 24 cooperating with the lower mold 22 is prepared. The upper mold 24 has inserting holes, and the structural parts 18 are inserted into the inserting holes of the upper mold 24. Then, the upper mold 24 and the lower mold 22 are closed to perform the hot press molding process as shown in FIG. 2D. In the hot press process, a molten part of the structural part 18 may be fused to the fiber-reinforced thermoplastic polymeric mat 16 and be combined with the molten thermoplastic plastic included by the polymeric mat, further to allow the structural part 18 to be molded on the fiber-reinforced thermoplastic polymeric mat 16. Particularly, in the hot press molding process, the fiber-reinforced thermoplastic polymeric mat 16, the buffer layer 14, and the fiber-reinforced thermosetting polymeric mat 12 are joined together. Then, after the molds are separated from each other, the casing 1 as shown in FIG. 1A is completed.

In another preferred embodiment, the buffer layer 14 can form a plurality of through holes 142 as shown in FIG. 1B in advance. In the hot press molding process, a part of the fiber-reinforced thermoplastic polymeric mat 16 may pass through the through holes 142 to be joined to the buffer layer 14 or the fiber-reinforced thermosetting polymeric mat 12. Thereby, the join strength of the fiber-reinforced thermoplastic polymeric mat 16, the buffer layer 14, and the fiber-reinforced thermosetting polymeric mat 12 is improved.

According to the preferred embodiments of the invention, the casing combines the advantages of the fiber-reinforced thermosetting polymer and the fiber-reinforced thermoplastic polymer applied to the casing manufacture and does not have the disadvantages of the two materials when they are respectively applied to the casing manufacture in the prior art. Further, one lower mold can be universally used in the vacuum molding process and the hot press molding process, which greatly improves feasibility of the mass production of the products.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for manufacturing a casing, the method comprising the following steps of:
(a) molding a fiber-reinforced thermosetting polymeric mat to allow the fiber-reinforced thermosetting polymeric mat to have a predetermined shape with a curved inner surface;
(b) disposing a fiber-reinforced thermoplastic polymeric mat on the inner surface of the fiber-reinforced thermosetting polymeric mat to allow the fiber-reinforced thermoplastic polymeric mat to agree with the curved inner surface; and
(c) molding the fiber-reinforced thermoplastic polymeric mat.

2. The method according to claim 1, wherein the step (c) is performed via a hot press molding process.

3. The method according to claim 1, wherein the step (c) further comprises the step of molding and joining a structural part to the fiber-reinforced thermoplastic polymeric mat via a hot press molding process.

4. The method according to claim 1, between the step (a) and the step (b), further comprising the following step of:
disposing a buffer layer on the inner surface of the fiber-reinforced thermosetting polymeric mat to allow the buffer layer to agree with the curved inner surface, wherein the fiber-reinforced thermoplastic polymeric mat is disposed on the buffer layer.

5. The method according to claim 4, wherein the buffer layer is made of a metal material or a polymer.

6. The method according to claim 4, wherein the buffer layer has a plurality of through holes, and in the step (c), a part of the fiber-reinforced thermoplastic polymeric mat passes through the through holes further to be joined to the buffer layer.

7. The method according to claim 4, wherein the buffer layer has a plurality of through holes, and in the step (c), a part of the fiber-reinforced thermoplastic polymeric mat passes through the through holes further to be joined to the fiber-reinforced thermosetting polymeric mat.

8. The method according to claim 1, wherein the fiber-reinforced thermosetting polymeric mat is molded via a vacuum molding process.

9. A casing comprising:
a fiber-reinforced thermosetting polymeric mat molded to have a predetermined shape with a curved inner surface; and
a fiber-reinforced thermoplastic polymeric mat molded on the inner surface of the fiber-reinforced thermosetting polymeric mat and agreeing with the curved inner surface.

10. The casing according to claim 9, further comprising a structural part molded and joined to the fiber-reinforced thermoplastic polymeric mat via a hot press molding process.

11. The casing according to claim 9, further comprising a buffer layer disposed between the fiber-reinforced thermoplastic polymeric mat and the fiber-reinforced thermosetting polymeric mat.

12. The casing according to claim 11, wherein the buffer layer is made of a metal material or a polymer.

13. The casing according to claim 11, wherein the buffer layer has a plurality of through holes, and a part of the fiber-reinforced thermoplastic polymeric mat passes through the through holes further to be joined to the buffer layer.

14. The casing according to claim 11, wherein the buffer layer has a plurality of through holes, and a part of the fiber-reinforced thermoplastic polymeric mat passes through the through holes further to be joined to the fiber-reinforced thermosetting polymeric mat.

15. The casing according to claim 9, wherein the opposite surface of the inner surface is a decorative outer surface of the casing.

16. The casing according to claim 9, wherein the fiber-reinforced thermosetting polymeric mat is molded via a vacuum molding process.
